(19) United States
(12) Patent Application Publication
(10) Pub. No.: US 2003/0196100 A1
(43) Pub. Date: Oct. 16, 2003

(54) Protection against memory attacks following reset

(76) Inventors: David W. Grawrock, Aloha, OR (US); David I. Poisner, Folsom, CA (US); James A. Sutton, Portland, OR (US)

Correspondence Address: John Patrick Ward, Esq., BLAKELY, SOKOLOFF, TAYLOR & ZAFMAN LLP, Seventh Floor, 12400 Wilshire Boulevard, Los Angeles, CA, 90025-1026, US

(21) Appl. No.: 10/123,599

(22) Filed: Apr. 15, 2002

(51) Int. Cl. G06F 12/14

(52) U.S. Cl. 713/193

(57) ABSTRACT

Methods, apparatus and computer readable medium are described that attempt to protect secrets from system reset attacks. In some embodiments, the memory is locked after a system reset and secrets removed from the memory before the memory is unlocked.

### BACKGROUND

Financial and personal transactions are being performed on local or remote computing devices at an increasing rate. However, the continual growth of such financial and personal transactions is dependent in part upon the establishment of security enhanced (SE) environments that attempt to prevent loss of privacy, corruption of data, abuse of data, etc.

An SE environment may employ various techniques to prevent different kinds of attacks or unauthorized access to protected data or secrets (e.g. social security number, account numbers, bank balances, passwords, authorization keys, etc.). One such type of attack is a system reset attack. Computing devices often support mechanisms for initiating a system reset. For example, a system reset may be initiated via a reset button, a LAN controller, a write to a chipset register, or a loss of power to name a few. Computing devices may employ processor, chipset, and/or other hardware protections that may be rendered ineffective as a result of a system reset. System memory, however, may retain all or a portion of its contents which an attacker may try to access following a system reset event.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference numerals have been repeated among the figures to indicate corresponding or analogous elements.

FIG. 1 illustrates an embodiment of a computing device.

FIG. 2 illustrates an embodiment of a security enhanced (SE) environment that may be established by the computing device of FIG. 1.

FIG. 3 illustrates an embodiment of a method to establish and dismantle the SE environment of FIG. 2.

FIG. 4 illustrates an embodiment of a method that the computing device of FIG. 1 may use to protect secrets stored in system memory from a system reset attack.

### DETAILED DESCRIPTION

The following description describes techniques for protecting secrets stored in a memory of a computing device from system reset attacks. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

References herein to “symmetric” cryptography, keys, encryption or decryption, refer to cryptographic techniques in which the same key is used for encryption and decryption. The well known Data Encryption Standard (DES) published in 1993 as Federal Information Publishing Standard FIPS PUB 46-2, and Advanced Encryption Standard (AES), published in 2001 as FIPS PUB 197, are examples of symmetric cryptography. Reference herein to “asymmetric” cryptography, keys, encryption or decryption, refer to cryptographic techniques in which different but related keys are used for encryption and decryption, respectively. So called “public key” cryptographic techniques, including the well-known Rivest-Shamir-Adleman (RSA) technique, are examples of asymmetric cryptography. One of the two related keys of an asymmetric cryptographic system is referred to herein as a private key (because it is generally kept secret), and the other key as a public key (because it is generally made freely available). In some embodiments either the private or public key may be used for encryption and the other key used for the associated decryption.

The verb “hash” and related forms are used herein to refer to performing an operation upon an operand or message to produce a digest value or a “hash”. Ideally, the hash operation generates a digest value from which it is computationally infeasible to find a message with that hash and from which one cannot determine any usable information about a message with that hash. Further, the hash operation ideally generates the hash such that determining two messages which produce the same hash is computationally impossible. While the hash operation ideally has the above properties, in practice one way functions such as, for example, the Message Digest 5 function (MD5) and the Secure Hashing Algorithm 1 (SHA-1) generate hash values from which deducing the message are difficult, computationally intensive, and/or practically infeasible.

Embodiments of the invention may be implemented in hardware, firmware, software, or any combination thereof. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

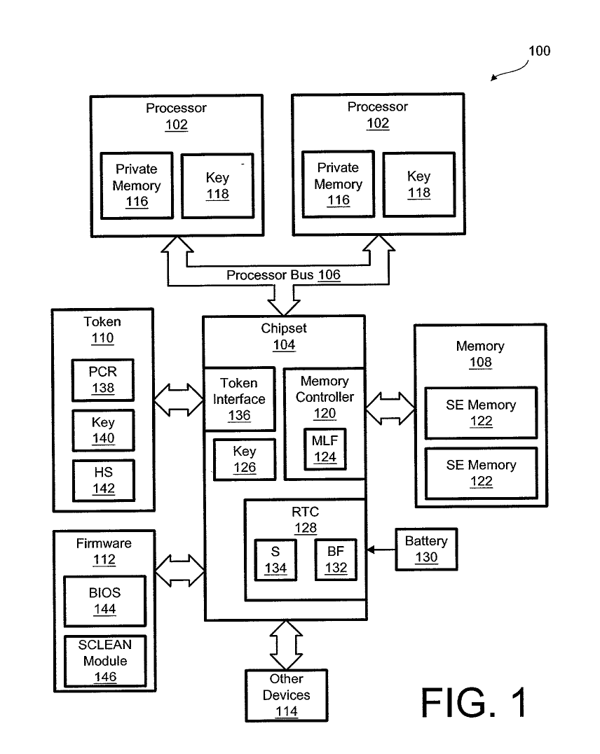

An example embodiment of a computing device 100 is shown in FIG. 1. The computing device 100 may comprise one or more processors 102 coupled to a chipset 104 via a processor bus 106. The chipset 104 may comprise one or more integrated circuit packages or chips that couple the processors 102 to system memory 108, a token 110, firmware 112 and/or other I/O devices 114 of the computing device 100 (e.g. a mouse, keyboard, disk drive, video controller, etc.).

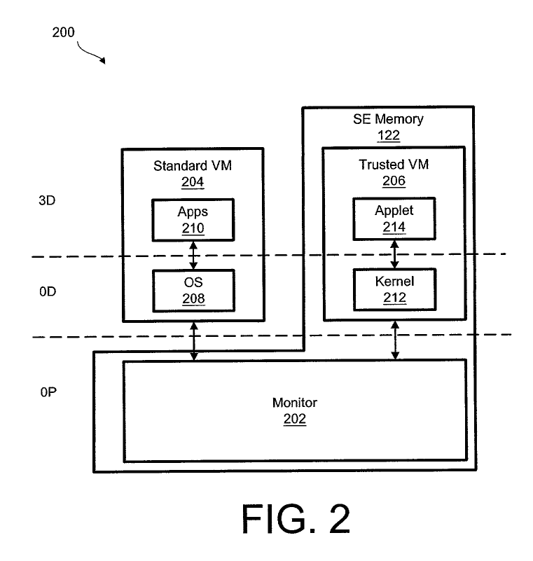

The processors 102 may support execution of a secure enter (SENTER) instruction to initiate creation of a SE environment such as, for example, the example SE environment of FIG. 2. The processors 102 may further support a secure exit (SEXIT) instruction to initiate dismantling of a SE environment. In one embodiment, the processor 102 may issue bus messages on processor bus 106 in association with execution of the SENTER, SEXIT, and other instructions. In other embodiments, the processors 102 may further comprise a memory controller (not shown) to access system memory 108.

Additionally, one or more of the processors 102 may comprise private memory 116 and/or have access to private memory 116 to support execution of authenticated code (AC) modules. The private memory 116 may store an AC module in a manner that allows the processor 102 to execute the AC module and that prevents other processors 102 and components of the computing device 100 from altering the AC module or interfering with the execution of the AC module. In one embodiment, the private memory 116 may be located in the cache memory of the processor 102. In another embodiment, the private memory 116 may be located in a memory area internal to the processor 102 that is separate from its cache memory. In other embodiments, the private memory 116 may be located in a separate external memory coupled to the processor 102 via a separate dedicated bus. In yet other embodiments, the private memory 116 may be located in the system memory 108. In such an embodiment, the chipset 104 and/or processors 102 may restrict private memory 116 regions of the system memory 108 to a specific processor 102 in a particular operating mode. In further embodiments, the private memory 116 may be located in a memory separate from the system memory 108 that is coupled to a private memory controller (not shown) of the chipset 104.

The processors 102 may further comprise a key 118 such as, for example, a symmetric cryptographic key, an asymmetric cryptographic key, or some other type of key. The processor 102 may use the processor key 118 to authentic an AC module prior to executing the AC module.

The processors 102 may support one or more operating modes such as, for example, a real mode, a protected mode, a virtual real mode, and a virtual machine mode (VMX mode). Further, the processors 102 may support one or more privilege levels or rings in each of the supported operating modes. In general, the operating modes and privilege levels of a processor 102 define the instructions available for execution and the effect of executing such instructions. More specifically, a processor 102 may be permitted to execute certain privileged instructions only if the processor 102 is in an appropriate mode and/or privilege level.

The processors 102 may further support launching and terminating execution of AC modules. In an example embodiment, the processors 102 may support execution of an ENTERAC instruction that loads, authenticates, and initiates execution of an AC module from private memory 116. However, the processors 102 may support additional or different instructions that result in the processors 102 loading, authenticating, and/or initiating execution of an AC module. These other instructions may be variants of the ENTERAC instruction or may be concerned with other operations. For example, the SENTER instruction may initiate execution of one or more AC modules that aid in establishing a SE environment.

In an example embodiment, the processors 102 further support execution of an EXITAC instruction that terminates execution of an AC module and initiates post-AC code. However, the processors 102 may support additional or different instructions that result in the processors 102 terminating an AC module and launching post-AC module code. These other instructions may be variants of the EXITAC instruction or may be concerned with other operations. For example, the SEXIT instruction may initiate execution of one or more AC modules that aid in dismantling an established SE environment.

The chipset 104 may comprise one or more chips or integrated circuits packages that interface the processors 102 to components of the computing device 100 such as, for example, system memory 108, the token 110, and the other I/O devices 114 of the computing device 100. In one embodiment, the chipset 104 comprises a memory controller 120. However, in other embodiments, the processors 102 may comprise all or a portion of the memory controller 120.

In general, the memory controller 120 provides an interface for other components of the computing device 100 to access the system memory 108. Further, the memory controller 120 of the chipset 104 and/or processors 102 may define certain regions of the memory 108 as security enhanced (SE) memory 122. In one embodiment, the processors 102 may only access SE memory 122 when in an appropriate operating mode (e.g. protected mode) and privilege level (e.g. 0P).

The memory controller 120 may further comprise a memory locked store 124 that indicates whether the system memory 108 is locked or unlocked. In one embodiment, the memory locked store 124 comprises a flag that maybe set to indicate that the system memory 108 is locked and that may be cleared to indicate that the system memory 108 is unlocked. In one embodiment, the memory locked store 124 further provides an interface to place the memory controller 120 in a memory locked state or a memory unlocked state. In a memory locked state, the memory controller 120 denies untrusted accesses to the system memory 108. Conversely, in the memory unlocked state the memory controller 120 permits both trusted and untrusted accesses to the system memory 108. In other embodiments, the memory locked store 124 may be updated to lock or unlock only the SE memory 122 portions of the system memory 108. In an embodiment, trusted accesses comprise accesses resulting from execution trusted code and/or accesses resulting from privileged instructions.

Further, the chipset 104 may comprise a key 126 that the processor 102 may use to authentic an AC module prior to execution. Similar to the key 118 of the processor 102, the key 126 may comprise a symmetric cryptographic key, an asymmetric cryptographic key, or some other type of key.

The chipset 104 may further comprise a real time clock (RTC) 128 having backup power supplied by a battery 130. The RTC 128 may comprise a battery failed store 132 and a secrets store 134. In one embodiment, the battery failed store 132 indicates whether the battery 130 ceased providing power to the RTC 128. In one embodiment, the battery failed store 132 comprises a flag that may be cleared to indicate normal operation and that may be set to indicate that the battery failed. Further, the secrets store 134 may indicate whether the system memory 108 might contain secrets. In one embodiment, the secrets store 134 may comprise a flag that may be set to indicate that the system memory 108 might contain secrets, and that may be cleared to indicate that the system memory 108 does not contain secrets. In other embodiments, the secrets store 134 and the battery failed store 132 may be located elsewhere such as, for example, the token 110, the processors 102, other portions of the chipset 104, or other components of the computing device 100.

In one embodiment, the secrets store 134 is implemented as a single volatile memory bit having backup power supplied by the battery 130. The backup power supplied by the battery maintains the contents of the secrets store 134 across a system reset. In another embodiment, the secrets store 134 is implemented as a non-volatile memory bit such as a flash memory bit that does not require battery backup to retain its contents across a system reset. In one embodiment, the secrets store 134 and battery failed store 132 are each implemented with a single memory bit that may be set or cleared. However, other embodiments may comprise a secrets store 134 and/or a battery failed store 132 having different storage capacities and/or utilizing different status encodings.

The chipset 104 may also support standard I/O operations on I/O buses such as peripheral component interconnect (PC), accelerated graphics port (AGP), universal serial bus (USB), low pin count (LPC) bus, or any other kind of I/O bus (not shown). A token interface 136 maybe used to connect chipset 104 with a token 110 that comprises one or more platform configuration registers (PCR) 138. In one embodiment, token interface 136 may be an LPC bus (Low Pin Count (LPC) Interface Specification, Intel Corporation, rev. 1.0, Dec. 29, 1997).

The token 110 may comprise one or more keys 140. The keys 140 may include symmetric keys, asymmetric keys, and/or some other type of key. The token 110 may further comprise one or more platform configuration registers (PCR registers) 138 to record and report metrics. The token 110 may support a PCR quote operation that returns a quote or contents of an identified PCR register 138. The token 110 may also support a PCR extend operation that records a received metric in an identified PCR register 138. In one embodiment, the token 110 may comprise a Trusted Platform Module (TPM) as described in detail in the Trusted Computing Platform Alliance (TCPA) Main Specification, Version 1.1a, Dec. 1, 2001 or a variant thereof.

The token 110 may further comprise a had-secrets store 142 to indicate whether the system memory 108 had contained or has ever contained secrets. In one embodiment, the had-secrets store 142 may comprise a flag that may be set to indicate that the system memory 108 has contained secrets at sometime in the history of the computing device 100 and that may be cleared to indicate that the system memory 108 has never contained secrets in the history of the computing device 100. In one embodiment, the had-secrets store 142 comprises a single, non-volatile, write-once memory bit that is initially cleared, and that once set may not be cleared again. The non-volatile, write-once memory bit may be implemented using various memory technologies such as, for example, flash memory, PROM (programmable read-only memory), EPROM (erasable programmable read-only memory), EEPROM (electrically erasable programmable read-only memory), or other technologies. In another embodiment, the had-secrets store 142 comprises a fused memory location that is blown in response to the had-secrets store 142 being updated to indicate that the system memory 108 has contained secrets.

The had-secrets store 142 may be implemented in other manners. For example, the token 110 may provide an interface that permits updating the has-secrets store 142 to indicate that the system memory 108 has contained secrets and that prevents updating the has-secrets store 142 to indicate that the system memory 108 has never contained secrets. In other embodiments, the had-secrets store 142 is located elsewhere such as in the chipset 104, processor 102, or another component of the computing device 100. Further, the had-secrets store 142 may have a different storage capacity and/or utilize a different status encoding.

In another embodiment, the token 110 may provide one or more commands to update the had-secrets store 142 in a security enhanced manner. In one embodiment, the token 110 provides a write command to change the status of the had-secrets store 142 that only updates the status of the had-secrets store 142 if the requesting component provides an appropriate key or other authentication. In such an embodiment, the computing device 100 may update the had-secrets store 142 multiple times in a security enhanced manner in order to indicate whether the system memory 108 had secrets.

In an embodiment, the firmware 112 comprises Basic Input/Output System routines (BIOS) 144 and a secure clean (SCLEAN) module 146. The BIOS 144 generally provides low-level routines that the processors 102 execute during system startup to initialize components of the computing device 100 and to initiate execution of an operating system. In one embodiment, execution of the BIOS 144 results in the computing device 100 locking system memory 108 and initiating the execution of the SCLEAN module 146 if the system memory 108 might contain secrets. Execution of the SCLEAN module 146 results in the computing device 100 erasing the system memory 108 while the system memory 108 is locked, thus removing secrets from the system memory 108. In one embodiment, the memory controller 120 permits trusted code such as the SCLEAN module 146 to write and read all locations of system memory 108 despite the system memory 108 being locked. However, untrusted code, such as, for example, the operating system is blocked from accessing the system memory 108 when locked.

The SCLEAN module may comprise code that is specific to the memory controller 120. Accordingly, the SCLEAN module 146 may originate from the manufacturer of the processor 102, the chipset 104, the mainboard, or the motherboard of the computing device 100. In one embodiment, the manufacturer hashes the SCLEAN module 146 to obtain a value known as a “digest” of the SCLEAN module 146. The manufacturer may then digitally sign the digest and the SCLEAN module 146 using an asymmetric key corresponding to a processor key 118, a chipset key 126, a token key 140, or some other key of the computing device 100. The computing device 100 may 146 then later verify the authenticity of the SCLEAN module using the processor key 118, chipset key 126, token key 140, or some other token of the computing device 100 that corresponds to the key used to sign the SCLEAN module 146.

One embodiment of an SE environment 200 is shown in FIG. 2. The SE environment 200 may be initiated in response to various events such as, for example, system startup, an application request, an operating system request, etc. As shown, the SE environment 200 may comprise a trusted virtual machine kernel or monitor 202, one or more standard virtual machines (standard VMs) 204, and one or more trusted virtual machines (trusted VMs) 206. In one embodiment, the monitor 202 of the operating environment 200 executes in the protected mode at the most privileged processor ring (e.g. 0P) to manage security and provide barriers between the virtual machines 204, 206.

The standard VM 204 may comprise an operating system 208 that executes at the most privileged processor ring of the VMX mode (e.g. 0D), and one or more applications 210 that execute at a lower privileged processor ring of the VMX mode (e.g. 3D). Since the processor ring in which the monitor 202 executes is more privileged than the processor ring in which the operating system 208 executes, the operating system 208 does not have unfettered control of the computing device 100 but instead is subject to the control and restraints of the monitor 202. In particular, the monitor 202 may prevent the operating system 208 and its applications 210 from directly accessing the SE memory 122 and the token 110.

The monitor 202 may perform one or more measurements of the trusted kernel 212 such as a hash of the kernel code to obtain one or more metrics, may cause the token 110 to extend a PCR register 138 with the metrics of the kernel 212, and may record the metrics in an associated PCR log stored in SE memory 122. Further, the monitor 202 may establish the trusted VM 206 in SE memory 122 and launch the trusted kernel 212 in the established trusted VM 206.

Similarly, the trusted kernel 212 may take one or more measurements of an applet or application 214 such as a hash of the applet code to obtain one or more metrics. The trusted kernel 212 via the monitor 202 may then cause the physical token 110 to extend a PCR register 138 with the metrics of the applet 214. The trusted kernel 212 may further record the metrics in an associated PCR log stored in SE memory 122. Further, the trusted kernel 212 may launch the trusted applet 214 in the established trusted VM 206 of the SE memory 122.

In response to initiating the SE environment 200 of FIG. 2, the computing device 100 further records metrics of the monitor 202 and hardware components of the computing device 100 in a PCR register 138 of the token 110. For example, the processor 102 may obtain hardware identifiers such as, for example, processor family, processor version, processor microcode version, chipset version, and physical token version of the processors 102, chipset 104, and physical token 110. The processor 102 may then record the obtained hardware identifiers in one or more PCR register 138.

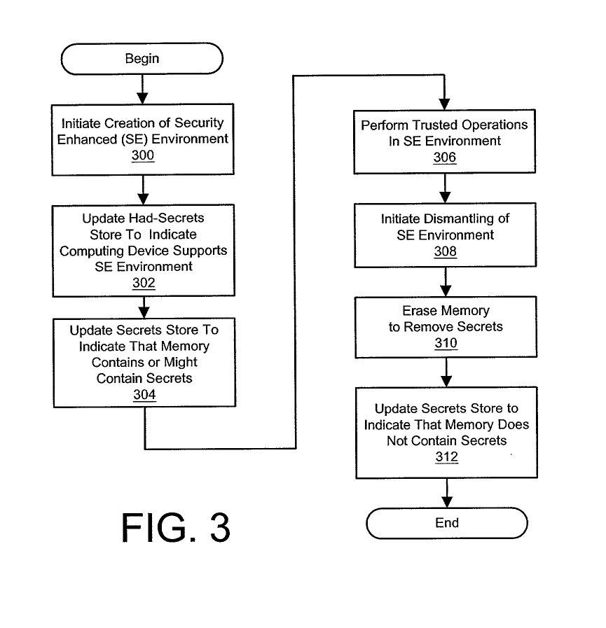

Referring now to FIG. 3, a simplified method of establishing the SE environment 200 is illustrated. In block 300, a processor 102 initiates the creation of the SE environment 200. In one embodiment, the processor 102 executes a secured enter (SENTER) instruction to initiate the creation of the SE environment 200. The computing device 100 may perform many operations in response to initiating the creation of the SE environment 200. For example, the computing device 100 may synchronize the processors 102 and verify that all the processors 102 join the SE environment 200. The computing device 100 may test the configuration of the computing device 100. The computing device 100 may further measure software components and hardware components of the SE environment 200 to obtain metrics from which a trust decision may be made. The computing device 100 may record these metrics in PCR registers 138 of the token 110 so that the metrics may be later retrieved and verified.

In response to initiating the creation of the SE environment 200, the processors 102 may issue one or more bus messages on the processor bus 106. The chipset 104, in response to one or more these bus messages, may update the had-secrets store 142 in block 302 and may update the secrets store 134 in block 304. In one embodiment, the chipset 104 in block 302 issues a command via the token interface 136 that causes the token 110 to update the had-secrets store 142 to indicate that the computing device 100 initiated creation of the SE environment 200. In one embodiment, the chipset 104 in block 304 may update the secrets store 134 to indicate that the system memory 108 might contain secrets.

In the embodiment described above, the had-secrets store 142 and the secrets store 134 indicate whether the system memory 108 might contain or might have contained secrets. In another embodiment, the computing device 100 updates the had-secrets store 142 and the secrets store 134 in response to storing one or more secrets in the system memory 108. Accordingly, in such an embodiment, the had-secrets store 142 and the secrets store 134 indicate whether in fact the system memory 108 contains or contained secrets.

After the SE environment 200 is established, the computing device 100 may perform trusted operations in block 306. For example, the computing device 100 may participate in a transaction with a financial institution who requires the transaction be performed in a SE environment. The computing device 100 in response to performing trusted operations may store secrets in the SE memory 122.

In block 308, the computing device 100 may initiate the removal or dismantling of the SE environment 200. For example, the computing device 100 may initiate dismantling of an SE environment 200 in response to a system shutdown event, system reset event, an operating system request, etc. In one embodiment, one of the processors 102 executes a secured exit (SEXIT) instruction to initiate the dismantling of the SE environment 200.

In response to initiating the dismantling of the SE environment 200, the computing device 100 may perform many operations. For example, the computer system 100 may shutdown the trusted virtual machines 206. The monitor 202 in block 310 may erase all regions of the system memory 108 that contain secrets or might contain secrets. After erasing the system memory 108, the computing device 100 may update the secrets store 134 in block 312 to indicate that the system memory 108 does not contain secrets. In another embodiment, the monitor 202 tracks with the secrets store 134 whether the system memory 108 contains secrets and erases the system memory 108 only if the system memory 108 contains secrets. In yet another embodiment, the monitor 202 tracks with the secrets store 134 whether the system memory 108 contained secrets and erases the system memory 108 only if the system memory 108 contained secrets.

In another embodiment, the computing device 100 in block 312 further updates the had-secrets store 142 to indicate that the system memory 108 no longer has secrets. In one embodiment, the computing device 100 provides a write command of the token 110 with a key sealed to the SE environment 200 and updates the had-secrets store 142 via the write command to indicate that the system memory 108 does not contain secrets. By requiring a key sealed to the SE environment 200 to update the had-secrets store 142, the SE environment 200 effectively attests to the accuracy of the had-secrets store 142.

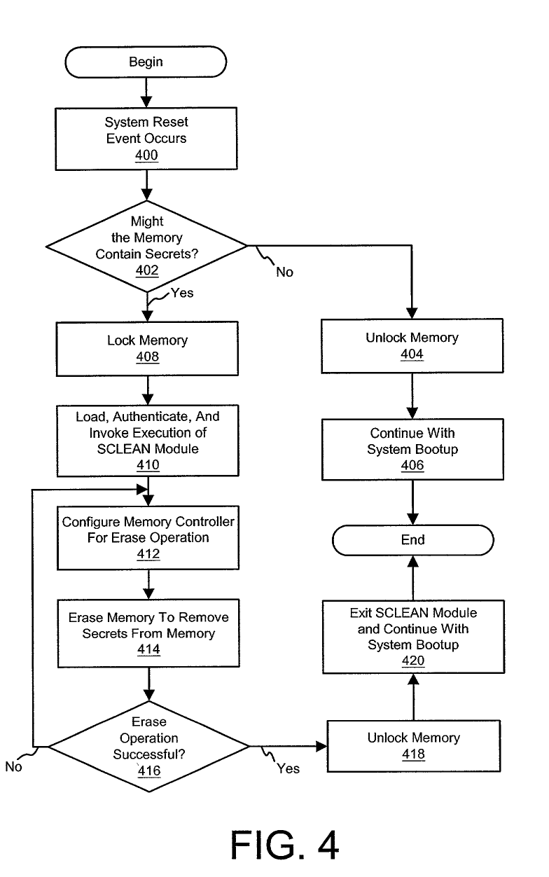

FIG. 4 illustrates a method of erasing the system memory 108 to protect secrets from a system reset attack. In block 400, the computing device 100 experiences a system reset event. Many events may trigger a system reset. In one embodiment, the computing device 100 may comprise a physical button that may be actuated to initiate a power-cycle reset (e.g. removing power and then re-asserting power) or to cause a system reset input of the chipset 104 to be asserted. In another embodiment, the chipset 104 may initiate a system reset in response to detecting a write to a specific memory location or control register. In another embodiment, the chipset 104 may initiate a system reset in response to a reset request received via a communications interface such as, for example, a network interface controller or a modem. In another embodiment, the chipset 104 may initiate a system reset in response to a brown out condition or other power glitch reducing, below a threshold level, the power supplied to a Power-OK or other input of the chipset 104.

In response to a system reset, the computing device 100 may execute the BIOS 144 as part of a power-on, bootup, or system initialization process. As indicated above, the computing device 100 in one embodiment removes secrets from the system memory 108 in response to a dismantling of the SE environment 200. However, a system reset event may prevent the computing device 100 from completing the dismantling process. In one embodiment, execution of the BIOS 144 results in the computing device 100 determining whether the system memory 108 might contain secrets in block 402. In an embodiment, the computing device 100 may determine that the system memory 108 might have secrets in response to determining that a flag of the secrets store 134 is set. In another embodiment, the computing device 100 may determine that the system memory 108 might have secrets in response to determining that a flag of the battery failed store 132 and a flag of the had-secrets store 142 are set.

In response to determining that the system memory 108 does not contain secrets, the computing device 100 may unlock the system memory 108 in block 404 and may continue its power-on, bootup, or system initialization process in block 406. In one embodiment, the computing device 100 unlocks the system memory 108 by clearing the memory locked store 124.

In block 408, the computing device 100 may lock the system memory 108 from untrusted access in response to determining that the system memory 108 might contain secrets. In one embodiment, the computing device 100 locks the system memory 108 by setting a flag of the memory locked store 124. In one embodiment, the BIOS 144 results in the computing device 100 locking/unlocking the system memory 108 by updating the memory locked store 124 per the following pseudo-code fragment:

IF BatteryFail THEN

IF HadSecrets THEN

MemLocked:=SET

ELSE

MemLocked:=CLEAR

END

ELSE

IF Secrets THEN

MemLocked:=SET

ELSE

MemLocked:=CLEAR

END

END

In one embodiment, the Secrets, BatteryFail, HadSecrets, and MemLocked variables each have a TRLE logic value when respective flags of the secrets store 134, the battery failed store 132, the had-secrets store 142, and the memory locked store 124 are set, and each have a FALSE logic value when the respective flags are cleared.

In an example embodiment, the flags of the secrets store 134 and the had-secrets store 142 are initially cleared and are only set in response to establishing the SE environment 200. See FIG. 3 and associated description. As a result, the flags of the secrets store 134 and the had-secrets store 142 will remain cleared if the computing device 100 does not support the creation of the SE environment 200. A computing device 100 that does not support and never has supported the SE environment 200 will not be rendered inoperable due to the BIOS 144 locking the system memory 108 if the BIOS 144 updates the memory locked store 124 per the above pseudo-code fragment or per a similar scheme.

In response to determining that the system memory 108 might contain secrets, the computing device 100 in block 410 loads, authenticates, and invokes execution of the SCLEAN module. In one embodiment, the BIOS 144 causes a processor 102 to execute an enter authenticated code (ENTERAC) instruction that causes the processor 102 to load the SCLEAN module into its private memory 116, to authenticate the SCLEAN module, and to begin execution of the SCLEAN module from its private memory 116 in response to determining that the SCLEAN module is authentic. The SCLEAN module may be authenticated in a number of different manners; however, in one embodiment, the ENTERAC instruction causes the processor 102 to authenticate the SCLEAN module as described in U.S. patent application Ser. No. 10/039,961, entitled Processor Supporting Execution of an Authenticated Code Instruction, filed Dec. 31, 2001.

In one embodiment, the computing device 100 generates a system reset event in response to determining that the SCLEAN module is not authentic. In another embodiment, the computing device 100 implicitly trusts the BIOS 144 and SCLEAN module 146 to be authentic and therefore does not explicitly test the authenticity of the SCLEAN module.

Execution of the SCLEAN module results in the computing device 100 configuring the memory controller 120 for a memory erase operation in block 412. In one embodiment, the computing device 100 configures the memory controller 120 to permit trusted write and read access to all locations of system memory 108 that might contain secrets. In one embodiment, trusted code such as, for example, the SCLEAN module may access system memory 108 despite the system memory 108 being locked. However, untrusted code, such as, for example, the operating system 208 is blocked from accessing the system memory 108 when locked.

In one embodiment, the computing device 100 configures the memory controller 120 to access the complete address space of system memory 108, thus permitting the erasing of secrets from any location in system memory 108. In another embodiment, the computing device 100 configures the memory controller 120 to access select regions of the system memory 108 such as, for example, the SE memory 122, thus permitting the erasing of secrets from the select regions. Further, the SCLEAN module in one embodiment results in the computing device 100 configuring the memory controller 120 to directly access the system memory 108. For example, the SCLEAN module may result in the computing device 100 disabling caching, buffering, and other performance enhancement features that may result in reads and writes being serviced without directly accessing the system memory 108

In block 414, the SCLEAN module causes the computing device 100 to erase the system memory 108. In one embodiment, the computing device 100 writes patterns (e.g. zeros) to system memory 108 to overwrite the system memory 108, and then reads back the written patterns to ensure that the patterns were in fact written to the system memory 108. In block 416, the computing device 100 may determine based upon the patterns written and read from the system memory 108 whether the erase operation was successful. In response to determining that the erase operation failed, the SCLEAN module may cause the computing device 100 to return to block 412 in an attempt to reconfigure the memory controller 120 (with possibly a different configuration) and to re-erase the system memory 108. In another embodiment, the SCLEAN module may cause the computing device 100 to power down or may cause a system reset event in response to a erase operation failure.

In response to determining that the erase operation succeeded, the computing device 100 in block 418 unlocks the system memory 108. In one embodiment, the computing device 100 unlocks the system memory 108 by clearing the memory locked store 124. After unlocking the system memory 108, the computing device 100 in block 420 exits the SCLEAN module and continues its bootup, power-on, or initialization process. In one embodiment, a processor 102 executes an exit authenticated code (EXITAC) instruction of the SCLEAN module which causes the processor 102 to terminate execution of the SCLEAN module and initiate execution of the BIOS 144 in order to complete the bootup, power-on, and/or system initialization process.

While certain features of the invention have been described with reference to example embodiments, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising:
locking a memory in response to determining that the memory might contain secrets; and
writing to the locked memory to overwrite secrets the memory might contain.

2. The method of claim 1 further comprising:
determining that the memory might contain secrets during a system bootup process.

3. The method of claim 1 further comprising:
updating a store to indicate that the memory might contain secrets; and
locking the memory in response to the store indicating that the memory might contain secrets.

4. The method of claim 3 wherein updating comprises:
updating the store to indicate that the memory might contain secrets in response to establishing a security enhanced environment; and
updating the store to indicate that the memory does not contain secrets in response to dismantling the security enhanced environment.

5. The method of claim 1 further comprising:
updating a store to indicate that the memory has contained secrets; and
locking the memory in response to the store indicating that the memory has contained secrets.

6. The method of claim 5 further comprising:
updating the store to indicate that the memory has contained secrets in response to establishing a security enhanced environment; and
preventing the store from being cleared after setting the store.

7. The method of claim 1 further comprising:
updating a first store having backup power to indicate whether the memory might contain secrets;
updating a second store to indicate whether the backup power failed;
updating an update-once third store to indicate that the memory might contain secrets in response to initiating a security enhanced environment; and
locking the memory in response to the first store indicating that the memory might contain secrets or in response to the second store indicating the backup power failed and the third store indicating that the memory might contain secrets.

8. The method of claim 1 wherein:
locking comprises locking untrusted access to the memory; and
writing comprises writing via trusted accesses to every location of the locked memory.

9. The method of claim 1 wherein:
locking comprises locking untrusted access to portions of the memory; and
writing comprises writing to the locked portions of the memory.

10. A method comprising:
locking a memory after a system reset event;
removing data from the locked memory; and
unlocking the memory after the data is removed from the memory.

11. The method of claim 10 wherein removing comprises writing to every physical location of the memory to overwrite the data.

12. The method of claim 10 wherein removing comprises:
writing one or more patterns to the memory; and
reading the one or more patterns back from the memory to verify that the one or more patterns were written to memory.

13. The method of claim 12 wherein:
locking comprises locking untrusted access to the memory; and
writing comprises writing via trusted accesses to every location of the memory.

14. The method of claim 12 wherein:
locking comprises locking untrusted access to portions of the memory; and
writing comprises writing to the locked portions of the memory.

15. A token comprising:
a non-volatile, write-once memory store that indicates that a memory has never contained secrets and that may be updated to indicate that the memory has contained secrets.

16. The token of claim 15 wherein:
the store comprises a fused memory location that is blown when the store is updated.

17. The token of claim 15 further comprising:
an interface to permit updating the flag to indicate that the memory has contained secrets and to prevent updating the flag to indicate that the memory has never contained secrets.

18. The token of claim 15 further comprising:
an interface to permit updating the flag to indicate that the memory had secrets and to permit updating the flag to indicate that the memory does not contain secrets in response to receiving an authorization key.

19. An apparatus comprising:
a memory locked store to indicate whether a memory is locked; and
a memory controller to deny untrusted accesses and permit trusted accesses to the memory in response to the memory locked store indicating that the memory is locked.

20. The apparatus of claim 19 further comprising:
a secrets store to indicate whether the memory might contain secrets.

21. The apparatus of claim 20 further comprising:
a battery failed store to indicate whether a battery that powers the secrets store has failed.

22. An apparatus comprising:
a memory to store secrets;
a memory locked store to indicate whether the memory is locked;
a memory controller to deny untrusted accesses to the memory in response to the memory locked store indicating that the memory is locked; and
a processor to update the memory locked store to lock the memory after a system reset in response to determining that the memory might contain secrets.

23. The apparatus of claim 22 further comprising a secrets flag to indicate whether the memory might contain secrets, the processor to update the secrets flag to indicate that the memory might contain secrets in response to a security enhanced environment being established and to update the secrets flag to indicate that the memory does not contain secrets in response to the security enhanced environment being dismantled.

24. The apparatus of claim 22 further comprising a secrets flag to indicate whether the memory might contain secrets, the processor to update the secrets flag to indicate that the memory might contain secrets in response to one or more secrets being stored in the memory and to update the secrets flag to indicate that the memory does not contain secrets in response to the one or more secrets being removed from the memory.

25. The apparatus of claim 22 further comprising:
a secrets flag to indicate whether the memory might contain secrets;
a battery to power the secrets flag; and
a battery failed store to indicate whether the battery failed.

26. The apparatus of claim 22 further comprising token, the token comprising:
a had-secrets store to indicate whether the memory had contained secrets; and
an interface to update the had-secrets flag only if an appropriate authentication key is received.

27. The apparatus of claim 25 further comprising a had-secrets store to indicate whether the memory has ever contained secrets, the had-secrets store immutable after updated to indicate that the memory has contained secrets.

28. The apparatus of claim 27 wherein the processor to update the memory locked flag after system reset based upon the secrets store, battery failed store, and the had-secrets store.

29. A computer readable medium comprising:
instructions that in response to being executed after a system reset, result in a computing device;
locking a memory based upon whether the memory might contain secrets;
removing the secrets from the locked memory; and
unlocking the memory after removing the secrets.

30. The computer readable medium of claim 29 wherein the instructions in response to being executed further result in the computing device determining that the memory might contain secrets based upon a secrets store that indicates whether a security enhanced environment was established without being completely dismantled.

31. The computer readable medium of claim 30 wherein the instructions in response to being executed further result in the computing device determining that the memory might contain secrets based upon a battery failed store that indicates whether a battery used to power the secrets store has failed.

32. The computer readable medium of claim 29 wherein the instructions in response to being executed further result in the computing device determining that the memory might contain secrets based upon a had-secrets store that indicates whether the memory had contained secrets.

33. A method comprising:
initiating a system startup process of a computing device; and
clearing contents of a system memory of the computing device during the system startup process.

34. The method of claim 33 wherein clearing comprises writing to every location of the system memory.

35. The method of claim 34 wherein clearing comprises writing to portions of the system memory that might contain secrets.
